(19) United States
(12) Patent Application Publication
(10) Pub. No.: US 2009/0076230 A1
(43) Pub. Date: Mar. 19, 2009

(54) Process for preparing compositionally uniform copolymers

(76) Inventors: Michael Thomas Sheehan, Corpus Christi, TX (US); James Ralph Sounik, Waynesville, OH (US); Hiroshi Okazaki, Corpus Christi, TX (US)

Correspondence Address: James J. Mullen, 8202 Campodolcino Drive, Corpus Christi, TX, 78414, US

(21) Appl. No.: 12/229,770

(22) Filed: Aug. 27, 2008

Related U.S. Application Data
(60) Provisional application No. 60/994,195, filed on Sep. 18, 2007.

(51) Int. Cl. C08F 2/04

(52) U.S. Cl. 526/60; 526/65

(57) ABSTRACT

This invention relates to semi-batch type copolymerization processes. More specifically, the processes of the present invention are directed to the production of compositionally uniform copolymers, including the production of such copolymers from dissimilar monomers, e.g., from monomers with significantly different reactivity ratios.

### FIELD OF THE INVENTION

This invention relates to semi-batch type copolymerization processes. More specifically, the processes of the present invention are directed to the production of compositionally uniform copolymers, including the production of such copolymers from dissimilar monomers, e.g., from monomers with significantly different reactivity ratios.

### BACKGROUND OF THE INVENTION

Typical copolymerizations are performed in the batch mode, where all monomers are charged at one time with or without solvent into a single reaction vessel and then a free radical or other polymerization initiator is added at the desired temperature to cause polymerization. However, using this batch procedure results in a polymer composition that is not uniform and/or a desired target and the molecular weight desired is not achieved. A semi-batch polymerization process is a modified batch process that seeks to address some of the deficiencies of a standard batch process for polymerization of monomers of different reactivities. In a semi-batch polymerization process, the reaction vessel is initially loaded with only a portion of the monomers and catalyst. Typically, the monomer(s) with lower reactivity will be present at a higher molar ratio during the initial charging of the vessel. As the reaction proceeds and monomers are consumed in the production of the copolymer, more monomers and optionally catalyst are fed to the reactor, at a ratio determined by both the relative reactivities of the monomers and the desired copolymer composition. This is generally referred to an “open loop” process and in the past has not been commercially successful because of its non-precise methodology utilized. In light of this facet, open loop semi-batch methodology, has not been used in processes to produce copolymers of high compositional uniformity in the chemical industry for use in photoresist applications The spectral characteristics of monomers and any polymers produced from these monomers are often quite similar, making it difficult to determine how much of any given monomer has been converted to polymer, thus the industry has resorted to the utilization of very automatic and sophisticated devices to carry out the desired end result. Under these circumstances, the economical costs are high and not feasible for some businesses. Therefore, there is a need in the industry for an inexpensive method to prepare these copolymers to achieve a target composition and a desired molecular weight. In U.S. Pat. No. 6,828,393 B1, there is disclosed a process wherein the desired end polymer is carried out in a two step process. In this manner, a test polymerization is conducted wherein two or more monomers are fed into a reactor vessel and then the reactor analyzed to determine the residual monomer content. Then the slower reacting monomer is fed to a second reactor and then the faster reactive monomer is fed to the reactor based upon the results from the first reactor study. This process still requires the use of two reactor vessels and the inaccurate analysis of the residual monomer in the first reactor vessel to determine the feed rates for the second reactor polymerization. This process is cumbersome and inaccurate in its methodology. Other attempts to carry out such open loop processes are disclosed in U.S. Pat. No. 5,504,166; both of these patents are incorporated herein by reference in toto.

### SUMMARY OF THE INVENTION

It has been found that the above disadvantages of the prior art can be over come by the present invention set forth herein. It has been found that an open loop process can be successfully carried out when the monomer conversion is predetermined by batch kinetics and analyzed by HPLC and GC and the proper open loop monomer feed sequence can then be applied to produce polymers of the desired compositional uniformity, without the utilization of such automatic and sophisticated devices/equipment.

In one aspect of this invention, there is provided a polymerization process for reacting monomers in a reaction vessel comprising:
a. charging a first vessel with a pre-charge of at least two monomers at a target composition, and a first solvent, and mixing the materials to form a uniform first solution;
b. charging a second vessel with a polymerization initiator and a second solvent, and mixing the materials to form a uniform second solution; and
c. feeding said first solution and said second solution into a third, reaction vessel at predetermined rates wherein said monomers in solution are polymerized over a sufficient period of time and at a sufficient temperature to maintain a target composition and achieve a desired molecular weight.

### DETAILED DESCRIPTION

Applicants have developed a semi-batch polymerization process that employs the controlled feed of monomers and initiator to a single reactor after using batch reaction kinetics data to establish the proper feed rates to achieve a desired molecular weight as well as a desired and uniform copolymer This process is especially useful for polymerizing monomers of widely varying polymerization reactivities (relative reactivity ratios greater than 2 or less than 0.5), but it can also be used for monomers of similar reactivities (relative reactivity ratios of between about 0.5 and 2).

One consequence of the ability to keep the liquid phase composition of the monomers constant is that copolymers made by the process of this invention have more uniformity in composition from chain-to-chain.

The impact of greater uniformity on the performance of the copolymers depends on both the nature of the copolymers and the application in which they are being used. It has been demonstrated, for example, that certain photoresist copolymers made by the process of this invention display improved line-edge roughness compared to copolymers made from the same monomers under standard batch process conditions.

The safety of certain polymerization processes can also be improved using the process of this invention, without sacrificing productivity. In a batch reactor, and particularly when one of the reactants is extremely reactive (e.g., acrylic acid), it is critically important from a process safety perspective that the polymerization exotherm be controlled. Typically, to achieve desireable reaction rates, high concentrations are used. A controlled feed reaction helps control the polymerization exotherm. To account for such exotherms, low concentration of monomer are commonly used limiting the reactor yield. Conversely, from an economic perspective it is highly desirable that the reactor be utilized to its maximum potential in each batch

The process of this invention combines the use of an initial batch copolymerization to obtain sufficient monomer conversion data with appropriate feed capability of maintaining the desired monomer concentrations throughout the course of a semi-batch copolymerization process by controlling the feed rates of each monomer as necessary and controlling the initiator feed rate.

The target liquid phase composition for the polymerization is determined before hand for a given target copolymer composition through the use of the classical polymer equation and is dependent upon the relative reactivities of each of the polymerizing monomers. The wider the disparity in reactivity ratios of the monomers, the more the target liquid phase composition will vary from the target copolymer composition. The monomer reactivity ratios can be obtained from kinetic studies of pair-wise copolymerizations or from non-linear parameter estimation techniques. Both of these techniques are well-known to those skilled in the art.

Analysis of reactivities of monomers suggest two approaches to attaining greater uniformity in the copolymerization of monomers that have different reactivities 1) to stop the reaction prior to complete conversion that will give the desired composition and 2) to start a standard polymerization process that gives the desired composition and to maintain the feed composition of the reaction by feeding the faster reacting monomer or monomers to the reaction and the reactions proceeds. For consideration of yield and commercial viability, only the second approach can has been used here.

The reactivities of each given set of monomers are determined by performing a series of conventional batch polymerizations at different monomer concentrations. Analysis of these polymerizations for the conversion of monomers through out the polymerization reaction can be used to determine the feed rate and concentration of monomers to be used in a controlled feed batch polymerization. A controlled feed batch polymerization can then be designed where the faster monomer or set of monomers can added at such a rate and concentration that maintains a constant monomer feed concentration at the desired composition. The process can be designed to feed the monomers as individual solutions of each monomer or as a mixture of monomers in solution. In the case of feeds using individual solution of each monomer, feed rates can be adjusted to compensate for the reactivity of each monomer.

The process of this invention can be used to make a variety of copolymers. The molecular weight of copolymers can be effectively controlled through the addition of a chain transfer agent (e.g., THF), the manipulation of the reaction temperature, or the rate of addition of free radical initiator. All of these methods for molecular weight control are well-known in the batch polymerization art. In one embodiment of this invention, a combination of initiator concentration and chain transfer agent concentration is used to regulate polymer molecular weight.

While one embodiment of this invention involves the polymerization of dissolved ASM with acrylate-type monomers, one skilled in the art would readily recognize the utility of the method to the free radical co-polymerization of other types of monomers, including styrenics and olefinics. Various type monomers can be used in the inventive step of the present invention, and are exemplified, without limitation, below.

Styrenics include, without limitation, a substituted styrene monomer of formula I,

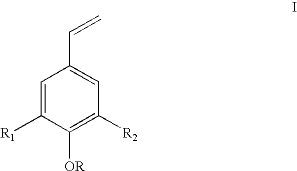

wherein R is either —C(O)R⁵ or —R⁵; in this formula I, the following are the definitions:
i) R¹ and R² are the same or different and independently selected from the group consisting of:
   hydrogen;
   fluorine, chlorine or bromine;
   alkyl or fluoroalkyl group having the formula CₙHₓF_{y} where n is an
   integer from 1 to 4, x and y are integers from 0 to 2n+1, and the
   sum of x and y is 2n+1; and
   phenyl or tolyl;
ii) R³ is selected from the group consisting of:
   hydrogen; and
   methyl, ethyl, n-propyl, iso-propyl, n-butyl, i-butyl or t-butyl;
iii) R⁴ is selected from the group consisting of methyl, ethyl, n-propyl, i-propyl, n-butyl,
   i-butyl, t-butyl, t-amyl, benzyl, cyclohexyl, 9-anthracenyl, 2-hydroxyethyl, cinnamyl, adamantly, methyl or ethyl adamantly, isobornyl, 2-ethoxyethyl, n-heptyl, n-hexyl, 2-hydroxypropyl, 2-ethylbutyl, 2-methoxypropyl, 2-(2-methoxyethoxyl), 2-naphthyl, 2-phenylethyl, phenyl, and the like.
iv) R⁵ is C₁-C₅ alkyl, either straight or branch chain.

Other monomers include, without limitation, an acrylate monomer having the formula II,

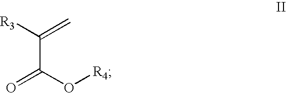

wherein the definition of R3 and R4 are the same as set forth above.

In conjunction with Formula II (an acrylate monomer) set forth herein, some preferred acrylate monomers are (1) MAA-methyl adamantyl acrylate, (2) MAMA-methyl adamantyl methacrylate, (3) EAA-ethyl adamantyl acrylate, (4) EAMA-ethyl adamantyl methacrylate, (5) ETCDA-ethyl tricyclodecanyl acrylate, (6) ETCDMA-ethyl tricyclodecanyl methacrylate, (7) PAMA-propyl adamantyl methacrylate, (8) MBAMA-methoxybutyl adamantyl methacrylate, (9) MBAA-methoxybutyl adamantyl acrylate, (10) isobornylacrylate, (11) isobornylmethacrylate, (12). cyclohexylacrylate, and (13) cyclohexylmethacrylate. Other preferred acrylate monomers which can be used are (14) 2-methyl-2-adamantyl methacrylate; (15) 2-ethyl-2-adamantyl methacrylate; (16) 3-hydroxy-1-adamantyl methacrylate; (17) 3-hydroxy-1-adamantyl acrylate; (18) 2-methyl-2-adamantyl acrylate; (19) 2-ethyl-2-adamantyl acrylate; (20) 2-hydroxy-1,1,2-trimethylpropyl acrylate; (21) 5-oxo-4-oxatricyclo-non-2-yl acrylate; (22) 2-hydroxy-1,1,2-trimethylpropyl 2-methacrylate; (23) 2-methyl-1-adamantyl methacrylate; (24) 2-ethyl-1-adamantyl methacrylate; (25) 5-oxotetrahydrofuran-3-yl acrylate; (26) 3-hydroxy-1-adamantyl methylacrylate; (27) 5-oxotetrahydrofuran-3-yl 2-methylacrylate;(28) 5-oxo-4-oxatricyclo-non-2-yl 2 methylacrylate; (28) 2-Propenoic acid, 2-hydroxy-1,1,2-trimethylpropyl ester (PinMAc); (29) 2-Methyl-2-propenoic acid, 2-hydroxy-1,1,2-trimethylpropyl ester (PinMAc); (30) 2-hydroxy-2,2-bis(trifluoromethyl)ethyl methacrylate, or 2-methyl-2-propenoic acid, 2-hydroxy-2,2-bis(trifluoromethyl)ethyl ester (FOHMAc); (31) 2-hydroxy-2,2-bis(trifluoromethyl)ethyl acrylate, or 2-propenoic acid, 2-hydroxy-2,2-bis(trifluoromethyl)ethyl ester (FOHAc).

Additional acrylates and other monomers that may be used in the present invention with the substituted styrene to form various copolymers include the following materials:

Monodecyl maleate; 2-hydroxy ethyl methacrylate; isodecyl methacrylate; hydroxy propyl methacrylate; isobutyl methacrylate; lauryl methacrylate; hydroxy propyl acrylate; methyl acrylate; t-butylaminoethyl methacrylate; isocyanatoethyl methacrylate; tributyltin methacrylate; sulfoethyl methacrylate; butyl vinyl ether blocked methacrylic acid; t-butyl methacrylate; 2-phenoxy ethyl methacrylate; acetoacetoxyethyl methacrylate; 2-phenoxy ethyl acrylate; 2-ethoxy ethoxy ethyl acrylate; beta-carboxyethyl acrylate; maleic anhydride; isobornyl methacrylate; isobornyl acrylate; methyl methacrylate; ethyl acrylate; 2-ethyl hexyl methacrylate; 2-ethyl hexyl acrylate; glycidyl methacrylate; N-butyl acrylate; benzyl methacrylate; acrolein; 2-diethylaminoethyl methacrylate; allyl methacrylate; vinyl oxazoline ester of meso methacrylate; itaconic acid; acrylic acid; N-butyl methacrylate; ethyl methacrylate; hydroxy ethyl acrylate; acrylamide oil; acrylonitrile; methacrylic acid; and stearyl methacrylate.

Further acrylates that can be used in the present invention include the following:
2-Methyl-2-adamantyl methacrylate (MAMA)
2-Methyl-2-adamantyl acrylate (MAA)
2-Ethyl-2-adamantyl methacrylate (EAMA)
2-Ethyl-2-adamantyl acrylate (EAA)
2-Ethyl-2-norbornyl methacrylate
3-Hydroxy-1-adamantyl acrylate (HAA)
3-Hydroxy-1-adamantyl methacrylate (HAMA)
α-γ-Butyrolactone methacrylate (α-GBLMA)
α-γ-Butyrolactone acrylate (α-GBLA)
Norbornene lactone methacrylate (NBLMA)
Norbornene lactone acrylate (NBLA)
Norbornene methacrylate (NOMA)
Norbornene acrylate (NOA)
Isobornyl methacrylate (IBMA)
Isobornyl acrylate (IBA)
Ethylcyclopentylmethacrylate (ECPMA)
Ethylcyclopentylacrylate (ECPA)
Ethylcyclohexylmethacrylate (ECHMA)
Ethylcyclohexylacrylate (ECHA)
2-(Cyanomethyl)-2-adamantylmethacrylate (CNMM)
2-Adamantyloxymethylmethacrylate (AOMM)
2-[(2-Methyl-adamantyl)oxy]carbonylmethylmethacrylate (MACMMA)

Other monomers include one or more ethylenically unsaturated copolymerizable monomers (EUCM) selected from the group consisting of styrene, 4-methylstyrene, styrene alkoxide wherein the alkyl portion is C₁-C₅ straight or branch chain, maleic anhydride, dialkyl maleate, dialkyl fumarate and vinyl chloride, wherein alkyl is having 1 to 4 carbon atoms, comprising the following steps.

Co-polymers having polyhydroxystyrene (PHS) and one or more of the above acrylate monomers are some of the materials that are made by the novel processes of the present invention.

In another embodiment, the reaction mixture may not only use the basic carboxylic acid solvent, but also use an additional co-solvent. The co-solvent is selected from the group consisting of tetrahydrofuran, methyl ethyl ketone, acetone, and 1,4-dioxane.

The carboxylic alcohol solvent is an alcohol having 1 to 4 carbon atoms and is selected from the group consisting of methanol, ethanol, isopropanol, tert-butanol, and combinations thereof The amount of solvent (and/or second solvent) used is not critical and can be any amount which accomplishes the desired end result.

The free radical initiator may be any initiator that achieves the desired end result. The initiator may be selected from the group consisting of 2,2′-azobis(2,4-dimethylpentanenitrile), 2,2′-azobis(2-methylpropanenitrile), 2,2′-azobis(2-methylbutanenitrile), 1,1′-azobis(cyclohexanecarbonitrile), t-butyl peroxy-2-ethylhexanoate, t-butyl peroxypivalate, t-amyl peroxypivalate, diisononanoyl peroxide, decanoyl peroxide, succinic acid peroxide, di(n-propyl)peroxydicarbonate, di(sec-butyl)peroxydicarbonate, di(2-ethylhexyl)peroxydicarbonate, t-butylperoxyneodecanoate, 2,5-dimethyl-2,5-di(2-ethylhexanoylperoxy)hexane, t-amylperoxyneodecanoate, dimethyl 2,2′-azobisisobutyrate and combinations thereof.

As a preferred embodiment, the initiator is selected from the group consisting of 2,2′-azobis(2,4-.dimethylpentanenitrile), 2,2′-azobis(2-metbylpropanenitrile), 2,2′-azobis(2-methylbutanenitrile), 1,1′-azobis(cyclohexanecarbonitrile), t-butyl peroxy-2-ethylhexanoate, t-butyl peroxypivalate, t-amyl peroxypivalate, and combinations thereof.

The amount of initiator is any amount that accomplishes the desired end result. However, as a preferred embodiment, said initiator is present to about three mole percent based upon the total moles of all of said monomers I, II, and said copolymerizable monomers.

The polymerization conditions are any temperature and pressure that will produce the desired end result. In general, the temperatures are from about 30° C. to about 100° C., preferably from about 40° C. to about 100° C., and most preferably from about 45° C. to about 90° C. The pressure may be atmospheric, sub-atmospheric or super-atmospheric. The polymerization time is not critical, but generally will take place over a period of at least one minute in order to produce a polymer of corresponding composition.

In one embodiment of this invention, the in-situ measurements are made by Raman spectroscopy. Equivalently, any in-line device that provides a measure of the molar composition of the liquid phase (FTIR, NIR, densitometry, GC, etc.) could be utilized.

### EXAMPLES

Unless otherwise noted, all compositions are given as mole %.

### Example 1

A 50 L round bottom glass reactor, fitted with an external heating mantle, an overhead stirrer, a chilled water reflux condenser and a nitrogen inlet and outlet was charged with 1,507.9 g of electronic grade methanol. The methanol was heated to reflux (65 deg. C.) at normal atmospheric pressure conditions with a low N2 sweep of approximately 1 L/min to remove all oxygen from the reactor. To a separate glass charge vessel, 834.5 g (3.36 moles) of 2,2′-azobis-2,4-dimethylvaleronitrile) (Vazo-52) was dissolved into 3557.4 g of electronic grade methanol and held at 25 deg. C. To a second glass charge vessel 6,048.0 g (37.33 moles) of 4-acetoxystyrene (ASM), 6,024 g (24.27 moles) of 2-ethyl-2-adamantylmethacrylate (EAMA) and 8,395 g of electronic grade methanol was mixed and held at 25 deg. C. Both charge vessels were outfitted with Teflon tubing and feed pumps leading to the 50 L reactor. After the main reactor charge of methanol had reached 65 deg. C., both charge vessels began feeding the monomer mix and initiator mix into the 50 L reactor. The feed rate of each vessel was separately set to completely feed their contents in 3.0 hours. One hour after both charge vessels had delivered their contents to the reactor, (four hours since the feeds were started) 208.62 g (0.84 moles) of Vazo-52 initiator dissolved in 500 g electronic grade methanol was added to the reactor in one charge. One hour later, (5 hours after feeds were started) 104.31 g (0.42 moles) of VAZO-52 as added to the reactor in one charge. One hour later, (6 hours after feeds were started) 52.15 g (0.21 moles) of Vazo-52 was added to the reactor. At each hour after start of the addition of monomers and initiator, a sample was taken and analyzed for unreacted monomers by capillary gas chromatography (GC). At seven hours, 775 g. of tetrahydrofuran (THF) was added to the reactor. At nine hours, an additional 482 g THF was added to the reactor. The THF was added to make the polymer more soluble and assist the mixing. The polymerization reaction was continued for a total of 10.5 hours. At the end of this period, the final polymer mixture sample showed conversion of ASM to be 95% and of EAMA to be 90% by weight conversion of the monomers to polymer. The polymer contents were allowed to cool to 55 deg. C. when an additional 6,230 g electronic grade methanol was added with mixing. The mixer was stopped and the contents let to settle, separating the bulk of the polymer layer to the bottom of the reactor. The upper methanol with residual monomers, initiator fragments and low molecular weight oligomers were removed with a dip tube and suction. An additional 1,660 g of THF and 12,850 g of methanol were added to the reactor. The reactor was heated again to 65 C and mixed for 60 minutes. The contents were allowed to settle and cool. The upper methanol layer (11,364 g) was again removed from the reactor and replaced with fresh methanol (12,750 g) and THF (1550 g). The reactor contents were again heated and stirred for 60 minutes, then allowed to settle and cool to 40 deg. C. This process was repeated a total of 6 times to achieve a greater than 99.9% replacement of the original methanol by dilution calculation. A final polymer sample was taken for analysis of residual monomers by capillary (GC). Residual ASM measured 324 ppm and residual EAMA measured 1900 ppm. The transesterification reactor of p-acetoxy groups to p-hydroxy groups was performed after adding an additional 9,034 g of methanol and 135 g of 25% sodium methoxide in methanol to the reactor and heating to reflux (65 deg. C.). The reaction mixture was continued to reflux with concomitant removal of methanol/methyl acetate as distillate and fresh methanol added to compensate for the distillate. The reaction mixture was allowed to react until the reaction mixture became clear in about 4 hours at which time the reaction mixture was allowed to react for an additional 7 hours to complete the reaction. A ¹³C NMR of the reaction mixture indicated a >98% conversion of p-acetoxy to p-hydroxy groups. A ¹H NMR analysis indicated that the 2-ethyl-2-adamantly groups remained intact and no poly(methacrylic acid) was detected. A ¹³C NMR for composition indicated a copolymer of 60 mole % 4-hydroxystyrene and 40 mole % EAMA.

### Example 2

A 3 L—four neck round bottom glass reactor, fitted with an external heating mantle, an overhead stirrer, a chilled water reflux condenser and a nitrogen inlet and outlet was charged with 166.3 g of methyl ethyl ketone, 47.8 g (0.118 moles) of methyl 4-cyano-4-(dodecylsulfanylthiocarbonyl)sulfanyl pentanoate, 2.0 g of sodium carbonate, and 2.6 g ( 0.011 moles) of dimethyl-2,2′-azobisisobutyrate. This mixture was heated to 67 deg. C. at normal atmospheric pressure conditions with a low N2 sweep of approximately 1 L/min to remove all oxygen from the reactor. To a separate glass charge vessel (vessel 1), 2-methyl-2-adamantylmethacrylate (MAMA) 362.0 g (1.548 moles) and held at 25 deg. C. To a second glass charge vessel (vessel 2), 248.0 g (1.457 moles) of α-γ-butyrolactone methacrylate (α-GBLMA), 172.7 g (0.731 moles) of 3-hydroxy-1-adamntylmethacrylate (HADMA), and 500 g of methyl ethyl ketone was mixed and held at 25 deg. C. Both charge vessels were outfitted with Teflon tubing and feed pumps leading to the 3 L reactor. After the reactor reached 67 deg. C., both charge vessels began feeding the monomer mixtures into reactor. The feed rate of vessel 1 was set to completely feed the entire contents in 3.0 hours and the feed rate of vessel 2 was set to completely feed the entire contents in 4.0 hours. At each hour after start of the addition of monomers and initiator, a sample was taken and analyzed for unreacted monomers by high performance liquid chromatography (HPLC). The polymerization reaction was continued for a total of 10 hours. At the end of this period the reaction was cooled to room temperature. The polymer mixture sample showed conversion of MAMA to be 81%, of O-GBLMA to be 91.5%, and HADMA to be 91.8% by weight conversion of the monomers to polymer. To this mixture, an additional 1.3 g of dimethyl-2,2′-azobisisobutyrate was added and then the mixture was heated to 67 deg. C. The mixture was maintained at 67 deg. C. for and additional 2.5 hours. The polymer contents were allowed to cool to room temperature and the solution was diluted with 720 g of methyl ethyl ketone. A final polymer sample was taken for analysis of residual monomers by high performance liquid chromatography (HPLC). The polymer mixture sample showed conversion of MAMA to be 90.7%, of alpha-GBLMA to be 97.4%, and HADMA to be 97.9% by weight conversion of the monomers to polymer. Analysis of the polymer by gel permeation chromatography gave a weight average molecular weight of 9,400 with a polydispersity of 1.18. The polymer was isolated by precipitation into 4500 g of stirred hexanes. The solid was filtered and washed with hexanes and then was dried under vacuum (15 torr) at 40 deg. C. for 72 hours. A total of 159.6 g of a fine yellow solid was obtained.

A 3 L—four neck round bottom glass reactor, fitted with an external heating mantle, an overhead stirrer, a chilled water reflux condenser and a nitrogen inlet and outlet was charged with the above isolated solid, 160.0 g of methyl ethyl ketone, 0.58 g of dimethyl-2,2′-azobisisobutyrate, and 18.6 g of triethylamine hypophosphorous acid salt. The reactor was heated to 67 deg. C. for a total of 10 hours with an addition of 0.34 g of dimethyl-2,2′-azobisisobutyrate at one hour intervals. The mixture was cooled to room temperature and polymer was isolated by precipitation into 6280 g of hexanes. The solid was filtered and washed with hexanes and then was dried under vacuum (15 torr) at 40 deg. C. for 72 hours. A total of 176.0 g of a fine white solid was obtained.

### Example 3

A 50-L 4-neck round bottom flask equipped with an overhead stirrer, heating mantle, thermo-well, thermocouple, N₂ sweep, chilled water condenser, and an addition inlet was charged with electronic grade methanol (1560.00 g). To a separate 5-L 1-neck round bottom flask was charged 2,2′-azobis-2,4-dimethylvaleronitrile (Vazo-52) (748.92 g, 3.02 moles) and electronic grade methanol (3192.8 g). To a separate 22-L 1-neck round bottom flask was charged ASM (7500.00 g, 42.29 moles), 2-ethyl-2-adamantylmethacrylate (EAMA) (3351.00 g, 13.50 moles), and electronic grade methanol (7540.00 g). The two smaller flasks were equipped with rubber stoppers to house the Teflon tubing leading to the 50-L reactor through feed pumps. The 50-L reactor was heated to 66° C. The smaller vessels were fed to the 50-L reactor at a rate so that the feed would be completed in 3 hours. The heat was turned off after 10.0 hours from the start of the feed. At this time a sample of the polymer was analyzed for conversion of monomer to polymer, ASM 97.4% and EAMA 97.9%. Methanol was charged (7220.00 g) and the reaction was stirred. The reactor was heated to 59° C. and stirred for 30 minutes. The stirring was stopped to allow the bulk polymer to settle out, the bottom layer. The top methanol layer (13,880.00 g), which contains residual monomers, initiator fragments and low molecular weight oligomers, was removed by with a dip tube and suction. Methanol (10,901.00) was slowly charged while stirring and heating (61.5° C). The mixture was stirred for 60 minutes. The contents were allowed to cool and settle. The top methanol layer (12,202.00 g) was removed by suction and methanol (12,322.00 g) was charged slowly while heating (65° C.) and stirring. The mixture was stirred for 60 minutes. The top layer (12,823.00 g) was removed and methanol (3320.00 g) was added. A sample of the polymer was analyzed for wt % residual monomers by GC, ASM <0.35% and EAMA 0.15%. The transesterification reaction of p-acetoxy groups to p-hydroxy groups was performed with the addition of methanol (4326.00 g) and 25 wt % sodium methoxide (121.40 g) in methanol and heating to 65° C. The reaction was allowed to reflux and the solution changed from opaque to clear after 1 hour. The heat was turned off after 7 hrs, methanol (1056.00 g) was charged to decrease the viscosity of the solution. The distillate, methanol and methyl acetate, was removed.

### Example 4

A 50-L 4-neck round bottom flask equipped with an overhead stirrer, heating mantle, thermo-well, thermocouple, N₂ sweep, chilled water condenser, and an addition inlet was charged with electronic grade methanol (1507.90 g). To a separate 5-L 1-neck round bottom flask was charged 2,2′-azobis-2,4-dimethylvaleronitrile (Vazo-52) (834.56 g, 3.36 moles) and electronic grade methanol (3557.40 g). To a separate 22-L 1-neck round bottom flask was charged ASM (6048.00 g, 37.33 moles), 2-ethyl-2-adamantylmethacrylate (EAMA) (6032.60 g, 24.30 moles), and electronic grade methanol (8395.00 g). The two smaller flasks were equipped with rubber stoppers to house the Teflon tubing leading to the 50-L reactor through feed pumps. The 50 L reactor was heated to 66° C. The smaller vessels were fed to the 50-L reactor at a rate so that the feed would be completed in 3 hours. Four hours after the feed had begun, Vazo-52 (208.62 g, 0.84 moles) and methanol (500.00 g) were added. Five hours after the feed had begun, more Vazo-52 (104.31 g, 0.42 moles) and methanol (300.00 g) were added. Six hours after the start of the feed, a final charge of Vazo-52 (52.15 g, 0.21 moles) and methanol (300.00 g) were added to the reactor. Seven hours after the start of the feed tetrahydrofuran (THF) (775.00 g) was added to increase solubility. Nine hours after the start of the feed, an additional amount of THF (482.00 g) was added. The heat was turned off at 10.5 hours. At this time a sample of the polymer was analyzed for conversion of monomer to polymer, ASM 94.5% and EAMA 89.5%. Methanol was charged (6230.00 g) and the reaction was stirred. The stirring was stopped to allow the bulk polymer to settle out, the bottom layer. The top methanol layer, which contains residual monomers, initiator fragments and low molecular weight oligomers, was removed by with a dip tube and suction. An additional portion of THF (2422 g) and methanol (10,365.00) were then charged to the reactor and the solution was then heated 66° C. for 60 minutes. The contents were allowed to cool and settle. The top methanol layer was removed by suction and methanol (12,842.00 g) and THF (1358.00 g) were charged to the reactor. The reaction was allowed to settle overnight (15.5 hrs). The top layer was removed and THF (1550 g) and methanol (1 2735 g) were added. The solution was stirred at 62° C. for 1.5 hrs then the stirring was stopped. The reaction sat overnight (17 hrs) and the top layer was removed (14,136 g). A sample of the polymer was analyzed for wt % residual monomers by GC, ASM <0.03% and EAMA 0.30%. The transesterification reaction of p-acetoxy groups to p-hydroxy groups was performed with the addition of methanol (9034 g) and 25 wt % sodium methoxide (135 g) in methanol and heating to 65° C. The reaction was allowed to reflux and the solution changed from opaque to clear after 2 hrs. The heat was turned off after 3.5 hrs and the distillate, methanol and methyl acetate, (2623 g) was removed. An additional amount of THF (1 kg) was added to decrease cloudiness of the solution. The solution was then filtered with a Meissner CSTMO. 1-552 Ultra dyne, 0.1 um, ⅜″ filter to remove Fe from Vazo 52. An additional amount of THF (1.4 kg) was added to decrease cloudiness of the solution.

### Example 5

A 3 L four neck round bottom glass reactor, fitted with an external heating mantle, temperature controller, thermowell, an overhead stirrer, a chilled water reflux condenser and a nitrogen inlet and outlet was charged with 647.4 g of Methyl Ethyl Ketone (MEK). In a separate container 15.63 g (dimethyl 2,2′-azobis(2-methylpropionate) (V-601) was dissolved into 40 g of MEK. The reactor contents was heated to 67° C. at normal atmospheric pressure conditions with a low N₂ sweep of approximately 1 L/min to remove all oxygen from the reactor. Once reactor contents reached reflux the V-601/MEK solution was added to the reactor. To a separate glass feed vessel, 192.8 g (6.8227 moles) of 2-methyl-2-adamantyl methacrylate (MAMA) was charged and held at 25° C. To a second separate glass feed vessel, 140.3 g (0.8245 moles) of α-γ-butyrolactone methacrylate (α-GBLMA), 97.5 g (0.4126 moles) of 3-hydroxy-1-adamantyl 2-methylacrylate (HAdMA) and 281.1 g of MEK was charged and held at 25° C. The charge vessels were outfitted with Teflon tubing and feed pump leading to the 3 L reactor. After the main reactor charge of MEK had reached reflux, the charge vessels began feeding the monomer mix and solvent mix into the 3 L reactor. The feed rate of the vessels was set to completely feed the contents in 3.0 hours for the MAMA and 4.0 hours for the α-GBLMA, HAdMA and MEK. Two hours after both charge vessels started delivering their contents to the reactor, 2.4 g (0.01 moles) of V-601 initiator dissolved in 3.7 g MEK was added to the reactor in one charge. The polymerization process continued for 4 additional hours. The polymerization reaction was continued for a total of 6 hours after monomers and solvent feeds were started. The reaction was allowed to cool to room temperature overnight. After the start of the addition of monomers and solvent, a sample was taken and analyzed for unreacted monomers by high performance liquid chromatography (HPLC) at 1, 2, 3, 4, 5 and 6 hours.

### Example 6

A 1 L four neck round bottom glass reactor, fitted with an external heating mantle, temperature controller, thermowell, an overhead stirrer, a chilled water reflux condenser and a nitrogen inlet and outlet was charged with 0.4271 g (1.80 moles) of Triethylamine (TEA), 10.5138 g (1.86 moles) of methyl 4-cyano-4-(dodecylsulfanythiocarbonl)sulfany pentanoate (CTA 2.2), 1.4126 g (0.12 moles) of 2,2′-Azobisisobutyronitrile (AIBN) and 109.17 g of Methyl Ethyl Ketone (MEK). The reactor contents was heated to 67 deg. C. at normal atmospheric pressure conditions with a low N₂ sweep of approximately 1 L/min to remove all oxygen from the reactor. To a separate glass feed vessel, 57.83 g (0.2097 moles) of 1,4:5,8-dimetano-2-ethyl-decahydronaphtalene-2-yl-methacrylate (MDDx), 14.23 g (0.0838 moles) of 1-ethylcyclopentyl-2-methacrylate (MCp2), 49.52 g (0.2096 moles) of 3-hydroxy-1-adamantyl 2-methylacrylate (MAdOH), 75.19 g (0.3354 moles) of 7-oxa-norbornane-5,3-carbolactone-2-yl-methacrylate (MONL) and 345.3 g of MEK was charged, stirred until monomers dissolved in solution and held at 25° C. The charge vessel was outfitted with Teflon tubing and feed pump leading to the 1 L reactor. After the main reactor charge of TEA, CTA 2.2, AIBN, and MEK had reached 67 deg. C., the charge vessel began feeding the monomer mix and solvent mix into the 1 L reactor. The feed rate of the vessel was set to completely feed the contents in 2.0 hours for the MDDx, MCp2, MAdOH, MONL, and MEK. The polymerization process continued for 4 additional hours. Six hours after the charge vessel started delivering their contents to the reactor 7.02 g (0.04 moles) of AIBN initiator dissolved in 3.31 g of 2-mercaptoethanol was added to the reactor in one charge. The reaction cooled to room temperature two hours after the addition of AIBN and 2-mercaptoethanol to the reaction.

### Example 7

A 5 L four neck round bottom glass reactor, fitted with an external heating mantle, temperature controller, thermowell, an overhead stirrer, a chilled water reflux condenser and a nitrogen inlet and outlet was charged with 301.40 g (1.72 moles) of 4-acetoxystyrene (ASM), 240.78 g (1.88 moles) of t-butylacrylate (tBA), 17.94 g (0.08 moles) of t-butylperoxypivalate (tBPP) and 648 g of electronic grade methanol. The reactor contents was heated to reflux (65° C.) at normal atmospheric pressure conditions with a low N₂ sweep of approximately 1 L/min to remove all oxygen from the reactor. To a separate glass feed vessel, 532.6 g (3.17 moles) of ASM and 362 g of electronic grade methanol was charged and held at 25 deg. C. To a second glass charge vessel 114.8 g (0.90 moles) tBA and 286 g of electronic grade methanol was mixed and held at 25 deg. C. Both charge vessels were outfitted with Teflon tubing and feed pumps leading to the 5 L reactor. After the main reactor charge of ASM, tBA, and methanol had reached 65 deg. C., both charge vessels began feeding the monomer mix and solvent mix into the 5 L reactor. The feed rate of each vessel was separately set to completely feed their contents in 6.0 hours for the ASM/methanol mixture and 4.0 hours for the tBA/Methanol mixture. Two hours after both charge vessels started delivering their contents to the reactor, 9.04 g (0.04 moles) of tBPP initiator dissolved in 10 g electronic grade methanol was added to the reactor in one charge. Two hours later, (4 hours after feeds were started) 6.02 g (0.03 moles) of tBPP and 10 g electronic grade methanol was added to the reactor in one charge. The tBA/methanol mixture charging was completed at 4 hours and the ASM/methanol mixture charging was completed at 6 hours after the charging was started. Six hours after feeds were started; 3.0 g (0.01 moles) of tBPP was added to the reactor. After the start of the addition of monomers and solvent, a sample was taken and analyzed for unreacted monomers by capillary gas chromatography (GC) at 1, 2, 3, and 5 hours. The polymerization reaction was continued for a total of 10 hours after monomers/methanol feed were started. The reaction was allowed to cool to room temperature overnight. A final sample was then taken and analyzed for unreacted monomers by GC. A charged of 1006 g of n-heptane was added to polymer mixture and stirred for ˜15 minutes. Stirring was stopped and solvent layers were allowed to separate. The upper n-heptane layer (512 g) was removed and replaced with fresh n-heptane (746 g). The reactor contents were again stirred for ˜15 minutes. Stirring was then stopped and solvent layers were allowed to separate. The upper n-heptane layer (846 g) was again removed and replaced with fresh n-heptane (615 g). The reactor contents were again stirred for ˜15 minutes. Stirring was then stopped to allow solvent layers to separate. The upper n-heptane layer (822 g) was removed for the final time. This process was repeated a total of 3 times to remove residual monomers remaining in polymer solution. The transesterification reactor of p-acetoxy groups to p-hydroxy groups was performed after adding an additional 510 g of methanol and 16.2 g of 25% sodium methoxide in methanol to the reactor and heating to reflux (65 deg. C.). The reaction mixture was continued to reflux with concomitant removal of methanol/methyl acetate as distillate and fresh methanol added to compensate for the distillate. The reaction mixture was allowed to react until the reaction mixture became clear in about 2 hours at which time the reaction mixture was allowed to react for an additional 5 hours to complete the reaction. A ¹³C NMR of the reaction mixture indicated a >98% conversion of acetoxy to hydroxy groups. A ¹H NMR analysis indicated that the t-butyl acrylate groups remained intact. A ¹³C NMR for composition indicated a copolymer of 66 mole % 4-hydroxystyrene and 34 mole % t-butylacrylate.

### Example 8

A 5 L four neck round bottom glass reactor, fitted with an external heating mantle, temperature controller, thermowell, an overhead stirrer, a chilled water reflux condenser and a nitrogen inlet and outlet was charged with 301.38 g (1.80 moles) of 4-acetoxystyrene (ASM), 239.04 g (1.86 moles) of t-butylacrylate (tBA), 26.91 g (0.12 moles) of t-butylperoxypivalate (tBPP) and 646.81 g of electronic grade methanol. The reactor contents was heated to reflux (65° C.) at normal atmospheric pressure conditions with a low N₂ sweep of approximately 1 L/min to remove all oxygen from the reactor. To a separate glass feed vessel, 532.5 g (3.17 moles) of ASM and 637.1 g of electronic grade methanol was charged and held at 25 deg. C. To a second glass charge vessel 115.1 g (0.90 moles) tBA and 137.3 g of electronic grade methanol was mixed and held at 25 deg. C. Both charge vessels were outfitted with Teflon tubing and feed pumps leading to the 5 L reactor. After the main reactor charge of ASM, tBA, and methanol had reached 65 deg. C., both charge vessels began feeding the monomer mix and solvent mix into the 5 L reactor. The feed rate of each vessel was separately set to completely feed their contents in 6.0 hours for the ASM/methanol mixture and 4.0 hours for the tBA/Methanol mixture. Two hours after both charge vessels started delivering their contents to the reactor, 13.46 g (0.06 moles) of tBPP initiator dissolved in 10 g electronic grade methanol was added to the reactor in one charge. Two hours later, (4 hours after feeds were started) 8.99 g (0.04 moles) of tBPP and 10 g electronic grade methanol was added to the reactor in one charge. The tBA/methanol mixture charging was completed at 4 hours and the ASM/methanol mixture charging was completed at 6 hours after charging was started. Six hours after feeds were started; 4.49 g (0.02 moles) of tBPP was added to the reactor. After the start of the addition of monomers and solvent, a sample was taken and analyzed for unreacted monomers by capillary gas chromatography (GC) at 1, 2, 3, 4, and 5 hours. The polymerization reaction was continued for a total of 10 hours after monomers/methanol feed were started. A final sample was taken and analyzed for unreacted monomers by GC at 10 hours and the reaction was cooled to room temperature overnight. A charged of 771 g of n-heptane was added to polymer mixture and stirred for ˜15 minutes. Stirring was stopped and solvent layers were allowed to separate. The upper n-heptane layer (680 g) was removed and replaced with fresh n-heptane (821 g). The reactor contents were again stirred for ˜15 minutes. Stirring was then stopped and solvent layers were allowed to separate. The upper n-heptane layer (860 g) was again removed and replaced with fresh n-heptane (800 g). The reactor contents were again stirred for ˜15 minutes. Stirring was then stopped to allow solvent layers to separate. The upper n-heptane layer (894 g) was removed for the final time. This process was repeated a total of 3 times to remove residual monomers remaining in polymer solution. The transesterification reactor of p-acetoxy groups to p-hydroxy groups was performed after adding an additional 410 g of methanol and 16.2 g of 25% sodium methoxide in methanol to the reactor and heating to reflux (65 deg. C.). The reaction mixture was continued to reflux with concomitant removal of methanol/methyl acetate as distillate and fresh methanol added to compensate for the distillate. The reaction mixture was allowed to react until the reaction mixture became clear in about 2 hours at which time the reaction mixture was allowed to react for an additional 5 hours to complete the reaction. A ¹³C NMR of the reaction mixture indicated a >98% conversion of acetoxy to hydroxy groups. A ¹H NMR analysis indicated that the t-butyl acrylate groups remained intact. A ¹³C NMR for composition indicated a copolymer of 65 mole % 4-hydroxystyrene and 35 mole % t-butylacrylate.

What is claimed is:

1. A polymerization process for reacting monomers in a reaction vessel, comprising: (a) charging a first vessel with a pre-charge of at least two monomers at a target composition, and a first solvent, and mixing the materials to form a uniform first solution; (b) charging a second vessel with a polymerization initiator and a second solvent, and mixing the materials to form a uniform second solution; and (c) feeding said first solution and said second solution into a third, reaction vessel at predetermined rates wherein said monomers in solution are polymerized over a sufficient period of time and at a sufficient temperature to maintain a target composition and achieve a desired molecular weight.

2. The process of claim 1, wherein an off line detection system comprising an analyzer that utilizes gas or liquid chromatography is used to sense liquid phase composition of monomers in the contents of the reaction vessel, and the results thereof are used to determine the feed ratios of the first solution and the second solution into the reaction vessel.

3. The process of claim 1, wherein the monomers are selected from the group consisting of, acrylates, methacrylates, cyclic olefins, and styrenics.

4. The process of claim 3, wherein the styrenic is 4-acetoxystyrene.

5. The process of claim 3, wherein the methacrylate is 2-ethyl-2-adamantylmethacrylate.

6. The process of claim 1, wherein the monomers have relative reactivity ratios between 0.5 and 2.

7. The process of claim 1, wherein the monomers have relative reactivity ratios greater than 2 or less than 0.5.

8. The process of claim 1 wherein the monomers are respectively and separately charged into a series of separate first vessels along with a solvent to form a series of first solutions and then these first solutions are charged separately into the reaction vessel at predetermined rates.
